(19) United States
(12) Patent Application Publication
(10) Pub. No.: US 2006/0017322 A1
(43) Pub. Date: Jan. 26, 2006

(54) Vehicular brake control device

(76) Inventors: Seiichi Kojima, Kariya-city (JP); Yasunori Sakata, Kariya-city (JP); Kiyohito Takeuchi, Kariya-city (JP)

Correspondence Address: POSZ LAW GROUP, PLC, 12040 SOUTH LAKES DRIVE, SUITE 101, RESTON, VA, 20191, US

(21) Appl. No.: 11/167,309

(22) Filed: Jun. 28, 2005

(30) Foreign Application Priority Data
Jul. 22, 2004 (JP) 2004-214433

(51) Int. Cl. B60T 8/40

(52) U.S. Cl. 303/139

(57) ABSTRACT

A master cylinder MC is connected to wheel cylinders via brake conduits, and electromagnetic opening/closing valves configured as two-position valves with two ports are provided in the brake conduits, respectively. A brake conduit connects an area among a brake conduit between an electromagnetic opening/closing valve and pressure increase control valves with an area among another brake conduit between another electromagnetic opening/closing valve and pressure increase control valves. The brake conduit therebetween is provided with an electromagnetic opening/closing valve formed from a two-position valve with two ports. By using such a configuration, various controls can be executed as required in the event of an emergency, in addition to normal braking including automatic braking.

### CROSS REFERENCE TO RELATED APPLICATION

This application is based upon and claims the benefit of Japanese Patent Application No. 2004-214433 filed on Jul. 22, 2004, the content of which are incorporated herein by reference.

### FIELD OF THE INVENTION

The present invention relates to a vehicular brake control device provided with a regulator.

### BACKGROUND OF THE INVENTION

A related vehicular brake control device provided with a regulator is disclosed in Japanese Patent Laid-Open Publication No. HEI 11-139273. FIG. 4 shows the configuration of a hydraulic circuit in the related vehicular brake control device.

As shown in the figure, the vehicular brake control device is provided with a master cylinder MC and a regulator RG, which are both driven in accordance with the operation of a brake pedal BP. The regulator RG is connected to an auxiliary hydraulic pressure source AS. Along with the master cylinder MC, both are connected to a low-pressure reservoir RS.

The auxiliary hydraulic pressure source AS is provided with a hydraulic pump HP and an accumulator Acc. The hydraulic pump HP is driven by an electric motor M, whereby brake fluid is sucked in and discharged from the low-pressure reservoir RS. Brake fluid discharged from the hydraulic pump HP is supplied to and accumulated in the accumulator Acc via a check valve CV6.

The electric motor M is designed to be driven in response to the hydraulic pressure within the accumulator Acc falling below a predetermined lower limit value; it is also stopped in response to the hydraulic pressure within the accumulator Acc rising above a predetermined upper limit value. Furthermore, brake fluid stored in the accumulator Acc in this manner is appropriately supplied as output hydraulic pressure to the regulator RG.

Hydraulic pressure output from the auxiliary hydraulic pressure source AS is input to the regulator RG. Using the output hydraulic pressure from the master cylinder MC as a pilot pressure, the regulator RG regulates this pressure to a regulator hydraulic pressure proportional to the pilot pressure. Since the basic configuration of the regulator RG is well known, such description regarding the regulator RG shall be omitted.

Connecting the master cylinder MC and front wheel cylinders Wfr, Wfl of the vehicle are brake conduits MF1, MF2 on the front wheel side, respectively. Electromagnetic opening/closing valves SA1 and SA2 formed from two-position valves with three ports are provided in the brake conduits MF1, MF2. These valves are also connected to a pressure increase control valve PC1 and a pressure increase control valve PC2, respectively, via brake conduits AF1 and AF2.

During a non-operation term when no current is supplied, the electromagnetic opening/closing valves SA1 and SA2 are set to valve positions where the master cylinder MC is connected to both the vehicle front wheel cylinders Wfr, Wfl. This is accomplished via the brake conduit AF1, the pressure increase control valve PC1, and the brake conduit MF1, as well as the brake conduit AF2, the pressure increase control valve PC2, and the brake conduit MF2. During an operation term when current is supplied, the master cylinder MC is closed from the vehicle front wheel cylinders Wfr, Wfl.

In addition, a brake conduit MR respectively connects the regulator RG and wheel cylinders Wrr, Wrl. Provided on the brake conduit MR is an electromagnetic opening/closing valve SA3, which is formed from a two-position valve with two ports. Furthermore, the brake conduit MR branches into brake conduits MR1, MR2 downstream of the electromagnetic opening/closing valve SA3. Provided on the branched brake conduit MR1 is a pressure increase control valve PC3 and a pressure decrease control valve PC7, whereas the branched brake conduit MR2 is provided with a pressure increase control valve PC4 and a pressure decrease control valve PC8.

The auxiliary hydraulic pressure source AS is connected downstream of the electromagnetic opening/closing valve SA3 via a brake conduit AM, and the brake conduit AM is provided with an electromagnetic opening/closing valve STR formed from a two-position valve with two ports.

In the vehicular brake control device as described above, the positions of the various valves SA1 to SA3, STR, and PC1 to PC8 are set as shown in the figure during a non-operation term when no current is supplied to the solenoids thereof. The valve positions are set different from that shown in the figure during an operation term when current is supplied to the solenoids thereof. Furthermore, it is possible to execute, in addition to normal braking, anti-skid control (hereinafter called “ABS control”), traction control (hereinafter called “TCS control”), as well as electronic stability control i.e., sideslip prevention control (hereinafter called “ESC control”) through regulating the positions of the various valves SA1 to SA3, STR, and PC1 to PC8 by supplying current to the solenoids thereof.

However, such a vehicular brake control device uses electromagnetic opening/closing valves SA1, SA2, which are formed from two-position valves with three ports. Therefore, in addition to complicating the valve configuration of the vehicular brake control device, there is a risk of further complication in the configuration of the hydraulic circuit.

Moreover, when brake hydraulic pressure from the regulator RG is applied to the wheel cylinders Wfr, Wfl in this vehicular brake control device, such pressure passes through different valves, i.e., the electromagnetic opening/closing valves SA1, SA2. Accordingly, there is a possibility that timings at which brake hydraulic pressure is transmitted to and cut off from the wheel cylinders Wfr, Wfl may be offset, and lead to the generation of an unstable braking force on right and left wheels.

### SUMMARY OF THE INVENTION

In view of the foregoing points, it is an object of the present invention to simplify the configuration of a vehicular brake control device by achieving a vehicular brake control device configuration using two positions with two ports.

Moreover, it is another object of the present invention to provide a vehicular brake control device capable of suppressing the generation of an offset in timings at which a fluid pressure is transmitted to and cut off from wheel cylinders, and generating a stable braking force on right and left wheels.

According to a first aspect of the present invention, first and second wheel cylinders are provided for generating a braking force to first and second wheels, and third and fourth wheel cylinders are provided for generating a braking force to third and fourth wheels. Furthermore, a first brake conduit is provided that branches into two downstream of a first electromagnetic opening/closing valve, and also connects to the master cylinder and first and second wheel cylinders via the first electromagnetic opening/closing valve. First and second pressure increase control valves are provided among the branched brake conduits of the first brake conduit, and are connected to the first and second wheel cylinders, respectively.

In addition, first and second pressure decrease control valves are provided downstream of the first and second pressure increase control valves, and allow the fluid generating fluid pressure that is to be applied to the first and second wheel cylinders to escape to the reservoir. A second brake conduit is provided that branches into two downstream of a second electromagnetic opening/closing valve and connects to the master cylinder and third and fourth wheel cylinders via the second electromagnetic opening/closing valve. Third and fourth pressure increase control valves are provided among the branched brake conduits of the second brake conduit, and are connected to the third and fourth wheel cylinders, respectively. Third and fourth pressure decrease control valves are provided downstream of the third and fourth pressure increase control valves, and allow the fluid generating fluid pressure that is to be applied to the third and fourth wheel cylinders to escape to the reservoir. A third brake conduit is provided that guides fluid pressure accumulated in the accumulator to a portion between the second electromagnetic opening/closing valve in the second brake conduit and the third and fourth pressure increase control valves via a third electromagnetic opening/closing valve. A fourth brake conduit is provided that connects the first brake conduit between the first electromagnetic opening/closing valve and the first and second pressure increase control valves, and also connects the second brake conduit between the second electromagnetic opening/closing valve and the third and fourth pressure increase control valves, via a fourth electromagnetic opening/closing valve. Furthermore, the first and fourth electromagnetic opening/closing valves are formed from two-position valves with two ports.

Such a vehicular brake control device configured as described above is capable of executing various controls as required in the event of an emergency, and during normal braking, with both the first and fourth electromagnetic opening/closing valves formed from two-position valves with two ports. Since it is therefore possible to configure the vehicular brake control device using two-position valves with two ports, both the valve and configurations of the brake conduit can be simplified to streamline the configuration of the vehicular brake control device.

In addition, the fluid pressure to be applied to the first and second wheel cylinders is only transmitted via either the first or fourth electromagnetic opening/closing valve. Therefore, fluid pressure can be simultaneously transmitted to the first and second wheel cylinders, and the transmission of brake hydraulic pressure to the first and second wheel cylinders can be simultaneously cut off when the first and fourth electromagnetic opening/closing valves are in a closed state.

Thus, a vehicular brake control device can be achieved that is capable of preventing the generation of an offset in timings at which the brake hydraulic pressure is transmitted to and cut off from the first and second wheel cylinders, as well as generating a stable braking force on the right and left wheels.

According to another aspect of the present invention, the first and second wheels correspond to both front wheels, the first and second wheel cylinders apply fluid pressure to both front wheels, respectively, the third and fourth wheels correspond to both rear wheels, and the third and fourth wheel cylinders apply fluid pressure to both rear wheels, respectively. In such a case, a sealing direction of a valve of the fourth electromagnetic opening/closing valve is set in a direction that only allows the fluid to flow from a side of the second brake conduit to a side of the first brake conduit.

With such a configuration, brake hydraulic pressure can still be generated to the front wheel system to secure front partial performance, even if there is a loss in power such as no generation of brake fluid pressure to the rear wheel system.

According to another aspect of the present invention, it is preferable for an orifice diameter of the fourth electromagnetic opening/closing valve to be set to a size that is at least 80% of an orifice diameter of the first and second pressure increase control valves.

By setting the orifice diameter of the fourth electromagnetic opening/closing valve in such a manner, the fourth electromagnetic opening/closing valve can be minimized while ensuring the transmission of sufficient fluid pressure downstream of the fourth electromagnetic opening/closing valve.

According to the first aspect of the present invention described above, during normal braking the first and second electromagnetic opening/closing valves are in an opened state, and the third and fourth electromagnetic opening/closing valves are in a closed state, whereas the first to fourth pressure increase control valves are in an opened state and the first to fourth pressure decrease control valves are in a closed state.

Thus, fluid pressure generated by the master cylinder is transmitted to the wheel cylinders via the first and second electromagnetic opening/closing valves. Since fluid pressure is also applied to the first and second wheel cylinders via the first electromagnetic opening/closing valve at this time, it is possible to apply fluid pressure without bias to the first and second wheel cylinders.

During anti-skid control, the first and third electromagnetic opening/closing valves are in a closed state, the second and fourth electromagnetic opening/closing valves are in an opened state, among the first to fourth pressure increase control valves corresponding to a wheel subject to control is controlled to an opened state and a closed state and among the first to fourth pressure decrease control valves corresponding to a wheel subject to control is controlled to an opened state and a closed state.

In addition, during traction control in which a braking force is applied to only the third and four wheels, the first and third electromagnetic opening/closing valves are in an opened state, and the second and fourth electromagnetic opening/closing valves are in a closed state, among the third and fourth pressure increase control valves corresponding to a wheel subject to control is controlled to an opened state and a closed state and among the third and fourth pressure decrease control valves corresponding to a wheel subject to control is controlled to an opened state and a closed state.

Furthermore, during traction control, brake assist control and sideslip prevention control in which a braking force is applied to any one of the four wheels, the first and second electromagnetic opening/closing valves are in a closed state, and the third and fourth electromagnetic opening/closing valves are in an opened state, among the first to fourth pressure increase control valves corresponding to a wheel subject to control is controlled to an opened state and a closed state and among the first to fourth pressure decrease control valves corresponding to a wheel subject to control is controlled to an opened state and a closed state.

Note that by using linear valves to form the third and second electromagnetic opening/closing valves, it is possible to gradually increase or decrease pressure to the first to fourth wheel cylinders. In this manner, pressure to all wheels can be gradually increased or decreased with a simple configuration.

### BRIEF DESCRIPTION OF THE DRAWINGS

Other objects, features and advantages of the present invention will be understood more fully from the following detailed description made with reference to the accompanying drawings. In the drawings:

FIG. 1 is a drawing showing a schematic configuration of a vehicular brake control device according to a first embodiment of the present invention;

FIG. 2 is a block diagram showing the relation between input and output of a brake ECU in the vehicular brake control device shown in FIG. 1;

FIG. 3 is a diagram showing the operating states of various valves during various controls; and

FIG. 4 is a drawing showing a schematic configuration of a vehicular brake control device according to related art.

### DETAILED DESCRIPTION OF THE PREFERRED EMBODIMENTS

The present invention will be described further with reference to various embodiments in the drawings.

### First Embodiment

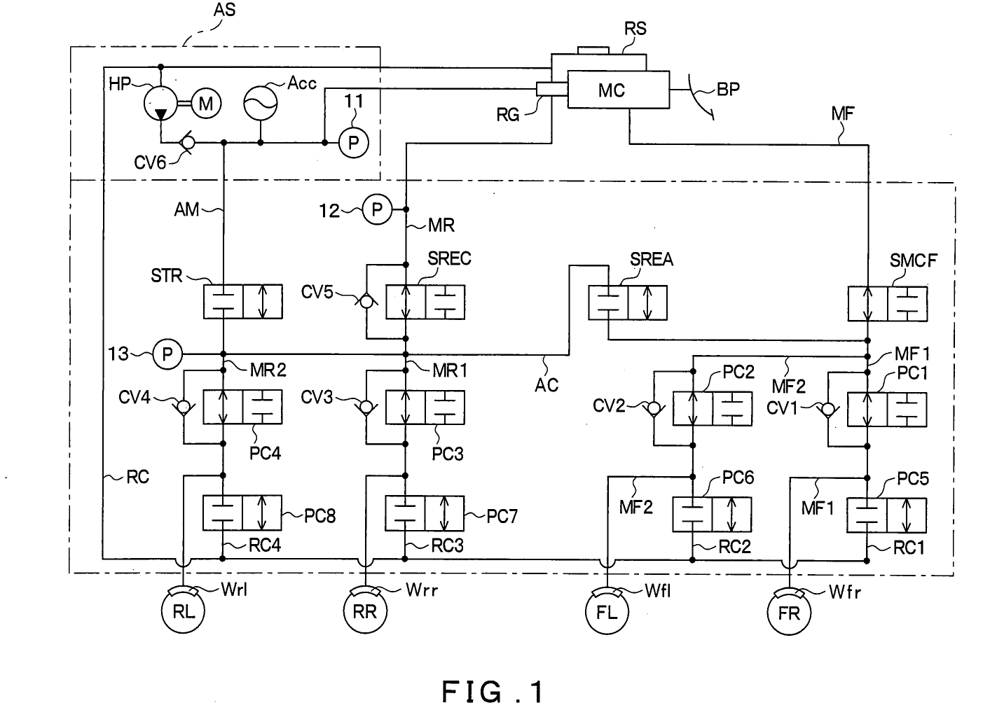

FIG. 1 shows a hydraulic circuit configuration of a vehicular brake control device to which an embodiment of the present invention is applied. Hereinbelow, the configuration of a vehicular brake control device according to the present embodiment will be described with reference to the figure.

As shown in FIG. 1, the vehicular brake control device is provided with a master cylinder MC and a regulator RG, which are both driven in accordance with the operation of a brake pedal BP. The regulator RG is connected to an auxiliary hydraulic pressure source AS. The auxiliary hydraulic pressure source AS and the master cylinder MC are both connected to a low-pressure reservoir RS.

The auxiliary hydraulic pressure source AS is provided with a hydraulic pump HP and an accumulator Acc. The hydraulic pump HP is driven by an electric motor M, whereby brake fluid is sucked in and discharged from the low-pressure reservoir RS. Brake fluid discharged from the hydraulic pump HP is supplied to and accumulated in the accumulator Acc via a check valve CV6.

The electric motor M is designed to be driven in response to the hydraulic pressure within the accumulator Acc falling below a predetermined lower limit value; it is also stopped in response to the hydraulic pressure within the accumulator Acc rising above a predetermined upper limit value. Furthermore, brake fluid stored in the accumulator Acc in this manner is appropriately supplied as output hydraulic pressure to the regulator RG.

Hydraulic pressure output from the auxiliary hydraulic pressure source AS is input to the regulator RG. Using the output hydraulic pressure from the master cylinder MC as a pilot pressure, the regulator RG regulates this pressure to a regulator hydraulic pressure proportional to the pilot pressure. The regulator hydraulic pressure is detected, for example, by a pressure sensor 11 corresponding to a hydraulic pressure monitoring mechanism to be described later, and is always kept within a predetermined range. Since the basic configuration of the regulator RG is well known, such description regarding the regulator RG shall be omitted.

Connecting the master cylinder MC and wheel cylinders Wfr, Wfl of front wheels FR, FL is a brake conduit (a first brake conduit) MF on the front wheel side. An electromagnetic opening/closing valve (a first electromagnetic opening/closing valve) SMCF formed from a two-position valve with two ports is provided in the brake conduit MF. Downstream of the electromagnetic opening/closing valve SMCF, the brake conduit MF branches into two brake conduits MF1, MF2. The brake conduits MF1, MF2 are formed provided with pressure increase control valves (first and second pressure increase control valves) PC1, PC2, respectively. The low-pressure reservoir RC is connected between the pressure increase control valves PC1, PC2 and wheel cylinders (first and second wheel cylinders) Wfr, Wfl of the front wheels FR, FL via brake conduits RC1, RC2. The brake conduits RC1, RC2 are provided with pressure decrease control valves (first and second pressure decrease control valves) PC5, PC6, respectively. Control for opening and closing the brake conduits RC1, RC2 is performed by the pressure decrease control valves PC5, PC6.

During a non-operation term when no current is supplied, the electromagnetic opening/closing valve SMCF is set to a valve position where the master cylinder MC is connected to both the wheel cylinders Wfr, Wfl of the front wheels FR, FL. This is accomplished via the brake conduits MF, MF1, MF2. However, during an operation term when current is supplied, the electromagnetic opening/closing valve SMCF is set to a valve position where the master cylinder MC is closed from the vehicle front wheel cylinders Wfr, Wfl.

In addition, a brake conduit (a second brake conduit) MR respectively connects the master cylinder MC and wheel cylinders (third and fourth wheel cylinders) Wrr, Wrl of rear wheels RR, RL. Provided on the brake conduit MR is an electromagnetic opening/closing valve (a second electromagnetic opening/closing valve) SREC, which is formed from a two-position valve with two ports. Furthermore, the brake conduit MR branches into brake conduits MR1, MR2 downstream of the electromagnetic opening/closing valve SREC. Provided on the branched brake conduit MR1 is a pressure increase control valve (a third pressure increase control valve) PC3 and a pressure decrease control valve (a third pressure decrease control valve) PC7, whereas the branched brake conduit MR2 is provided with a pressure increase control valve (a fourth pressure increase control valve) PC4 and a pressure decrease control valve (a fourth pressure decrease control valve) PC8.

The auxiliary hydraulic pressure source AS is connected downstream of the electromagnetic opening/closing valve SREC via a brake conduit (a third brake conduit) AM, and the brake conduit AM is provided with an electromagnetic opening/closing valve (a third electromagnetic opening/closing valve) STR formed from a two-position valve with two ports.

An area among the brake conduit MR between the electromagnetic opening/closing valve SREC and the pressure increase control valves PC3, PC4 is connected to the electromagnetic opening/closing valve SMCF and the pressure increase control valves PC1, PC2 on the brake conduit MF via a brake conduit (a fourth brake conduit) AC. The brake conduit AC is provided with an electromagnetic opening/closing valve (a fourth electromagnetic opening/closing valve) SREA formed from a two-position valve with two ports. Control for opening and closing the brake conduit AC is performed by the electromagnetic opening/closing valve SREA.

Check valves CV1 to CV4 are connected in parallel with the pressure increase control valves PC1 to PC4, respectively. Due to the check valves CV1 to CV4, brake fluid is only allowed to flow upstream from the downstream side of the pressure increase control valves PC1 to PC4 (on the wheel cylinder Wfr to Wfl side). In addition, the electromagnetic opening/closing valve SREC is also connected in parallel with a check valve CV5. Even if the electromagnetic opening/closing valve SREC is closed due to a control, the check valve CV5 only allows brake fluid to flow downstream side from the upstream side (the regulator RG side) of the electromagnetic opening/closing valve SREC, if the pressure generated by the brake operation of the driver is larger.

Also provided in the vehicular brake control device are pressure sensors 11 to 13 for detecting a brake hydraulic pressure at locations within the hydraulic circuit. The pressure sensor 11 is used to detect a brake hydraulic pressure accumulated in the accumulator Acc. The pressure sensor 12 is used to detect a brake hydraulic pressure generated by the master cylinder MC, and is installed further upstream than the electromagnetic opening/closing valve SREC in the brake conduit MR. The pressure sensor 13 is used to detect a brake hydraulic pressure generated downstream of the electromagnetic opening/closing valve SREC.

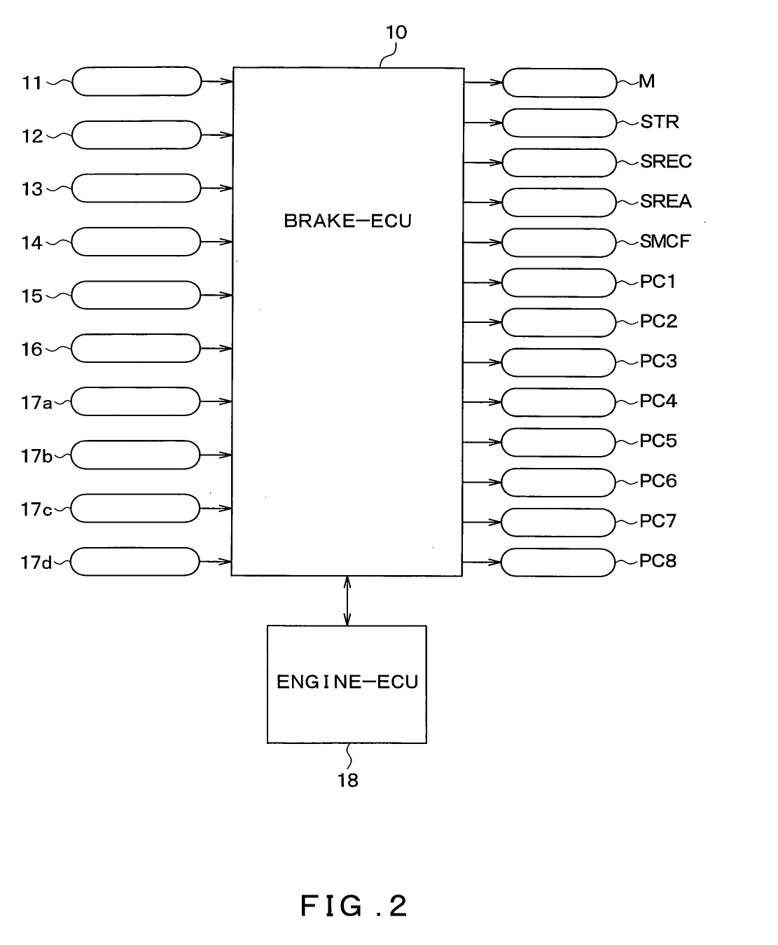

As shown in FIG. 2, a brake ECU 10 corresponding to a control mechanism is provided in the vehicular brake control device with the aforementioned configuration. The brake ECU 10 is designed to input the following signals: detection signals from the pressure sensors 11 to 13; detection signals from a yaw rate sensor 14, a G (acceleration) sensor 15 and a steering angle sensor 16 installed at arbitrary locations in the vehicle; and control signals from an engine ECU 18 and wheel speed sensors 17a to 17d provided for each wheel. Based upon the various detection and control signals, the brake ECU 10 is also designed to output drive signals to the various valves SMCF, SREC, STR, SREA, PC1 to PC8 and the electric motor M. Thus, the regulator hydraulic pressure is controlled so as to remain within a predetermined range, and brake hydraulic pressure to be applied to the wheel cylinders Wfr to Wrl is also controlled.

More specifically, the positions of the various valves SMCF, SREC, STR, SREA, and PC1 to PC8 are set as shown in the figure during a non-operation term when no current is supplied to the solenoids thereof. However, the valve positions are set different from that shown in the figure during an operation term when current is supplied to the solenoids thereof. Furthermore, it is possible to execute, in addition to normal braking, ABS control, TCS control, as well as ESC control through regulating the positions of the various valves SMCF, SREC, SREA, STR, and PC1 to PC8 by running current to the solenoids thereof.

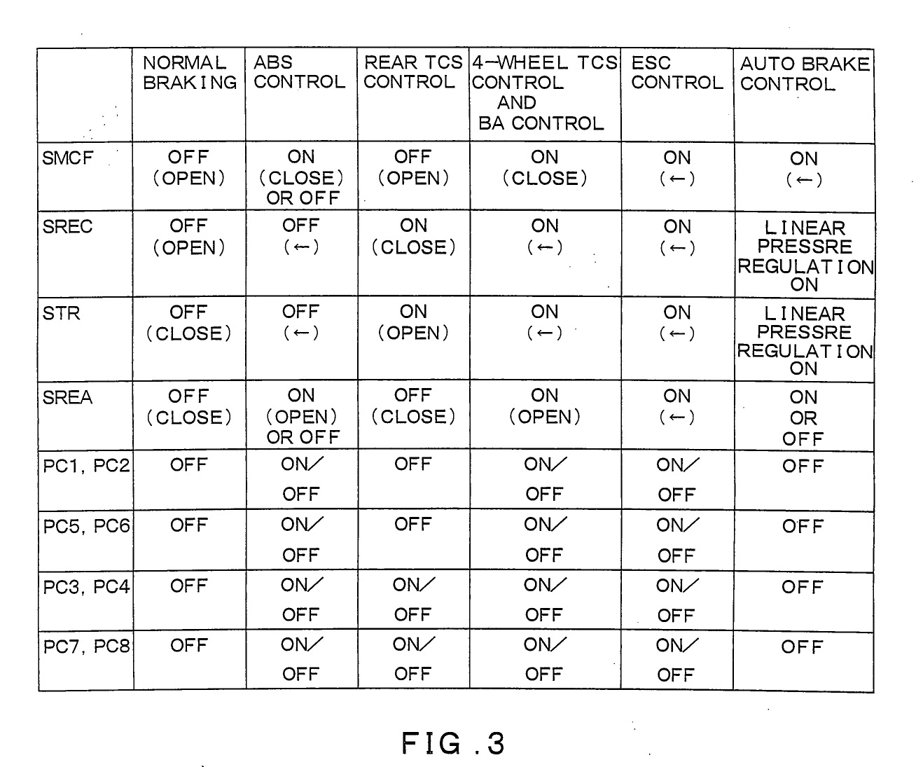

FIG. 3 shows the operating states of various valves during various controls. While referring to this figure, operations of the vehicular brake control device during various controls will be described below. The operation descriptions will be separated according to the time of execution as follows: normal braking, ABS control, TCS control for rear wheels only (hereinafter called “rear TCS control”), TCS control for all four wheels (hereinafter called “4-wheel TCS control”), brake assist control (hereinafter called “BA control”), and ESC control. It should be noted that the detection and control signals used for the various controls, as well as the calculations and the like using these signals, are well known and thus descriptions therefor are omitted.

[Normal Braking]

During normal braking, all current to the electromagnetic opening/closing valves SMCF, SREA, STR, SREC is kept OFF; likewise, all current to the pressure increase control valves PC1 to PC4 and the pressure decrease control valves PC5 to PC8 is also kept OFF. In other words, the electromagnetic opening/closing valves STR and SREA are in a closed state, and the electromagnetic opening/closing valves SREC and SMCF are in an opened state. The pressure increase control valves PC1 to PC4 are also in an opened state, while the pressure decrease control valves PC5 to PC8 are in a closed state.

Since the electromagnetic opening/closing valve STR is closed, brake hydraulic pressure accumulated in the accumulator Acc is therefore not transmitted to the wheel cylinders Wfr to Wrl. However, brake hydraulic pressure generated by the master cylinder MC is transmitted to the wheel cylinders Wfr, Wfl via the electromagnetic opening/closing valve SMCF, because the electromagnetic opening/closing valves SMCF and SREC are in an opened state. Likewise, brake hydraulic pressure generated by the regulator RG is transmitted to the wheel cylinders Wrr, Wrl via the electromagnetic opening/closing valve SREC, because the electromagnetic opening/closing valve SREC is also in an opened state.

[ABS Control]

The positions of the various valves during ABS control is that same as that for normal braking. Alternatively, current to the electromagnetic opening/closing valves STR, SREC may be kept OFF, and current to the electromagnetic opening/closing valves SMCF, SREA may be turned ON. In other words, the electromagnetic opening/closing valves STR and SMCF are in a closed state, and the electromagnetic opening/closing valves SREC and SREA are in an opened state. With regards to the wheels subjected to ABS control as well, the pressure increase control valves PC1 to PC4 and the pressure decrease control valves PC5 to PC8 perform operations different from that during normal braking.

First, at a pressure decrease timing during ABS control, current to both the pressure increase control valves PC1 to PC4 and the pressure decrease valves PC5 to PC8 is turned ON. Consequently, the pressure increase control valves PC1 to PC4 become a closed state, while the pressure decrease control valves PC5 to PC8 become an opened state. Thus, brake hydraulic pressure to be applied to the wheel cylinders Wfr to Wrl is allowed to escape to the low-pressure reservoir RC side via the pressure decrease control valves PC5 to PC8.

At a pressure maintain timing during ABS control, current to the pressure increase control valves PC1 to PC4 is turned ON, while current to the pressure decrease control valves PC5 to PC8 is turned OFF. Consequently, the pressure increase control valves PC1 to PC4 and the pressure decrease control valves PC5 to PC8 all become a closed state, such that the brake hydraulic pressure to be added to the wheel cylinders Wfr to Wrl is maintained.

At a pressure increase timing during ABS control, current to the pressure increase control valves PC1 to PC4 is repeatedly switched ON and OFF, while current to the pressure decrease control valves PC5 to PC8 is turned OFF. Consequently, the brake hydraulic pressure to be added to the wheel cylinders Wfl to Wrr is increased in pulses via the pressure increase control valves PC1 to PC4.

[Rear TCS Control]

In rear TCS control, the rear wheels RR, RL are subject to control, and a TCS control is executed by applying brake hydraulic pressure on the wheel cylinders Wrr, Wrl corresponding to the wheels subject to control.

During rear TCS control, first, current to the electromagnetic opening/closing valves STR, SREC is turned ON, while current to the electromagnetic opening/closing valves SMCF, SREA is turned OFF. In addition, current is appropriately switched ON and OFF to the pressure increase control valves PC3, PC4 and pressure decrease control valves PC7, PC8, which correspond to the wheels subject to rear TCS control.

Since the electromagnetic opening/closing valve STR becomes an opened state in this case, the brake hydraulic pressure accumulated in the accumulator Acc is transmitted via the electromagnetic opening/closing valve STR. However, since the electromagnetic opening/closing valve SREA is in a closed state, brake hydraulic pressure is not transmitted to the wheel cylinders Wfr, Wfl corresponding to the front wheels FR, FL; brake hydraulic pressure is only transmitted to the wheel cylinders Wrr, Wrl corresponding to the wheels subject to control, that is, the rear wheels RR, RL.

Accordingly, a braking force is generated on the rear wheels RR, RL subject to control, and a driving force is decreased so as to avoid wheel slippage. It should be noted that since the electromagnetic opening/closing valve SMCF is in an opened state during the rear TCS control, the master cylinder MC is connected to the wheel cylinders Wfr, Wfl corresponding to the front wheels FL, FR, whereby a braking force can be generated on the front wheels FR, FL.

[4-Wheel TCS Control, BA Control, and ESC Control]

In 4-wheel TCS control, the four wheels FR to RL are subject to control, and a TCS control is executed by applying brake hydraulic pressure on the wheel cylinders Wfr to Wrl corresponding to the wheels subject to control. In BA control, the four wheels FR to RL are subject to control, where brake hydraulic pressure is applied to the wheel cylinders Wfr to Wrl corresponding to the wheels subject to control. The BA control is executed when a braking force larger than that during normal braking is desired, such as in cases where the depression force on a brake pedal BP exceeds a predetermined value. In ESC control, brake hydraulic pressure is applied to the wheel cylinders Wfr to Wrl corresponding to the wheels subject to control in order to avoid a state in which sideslip may occur, such as when a sideslip angle calculated from the yaw rate sensor 14, the steering angle sensor 16 or the like exceeds a predetermined value.

The driving states of the various valves during the 4-wheel TCS control, BA control, and ESC control will be described together hereinbelow, given that the driving states of the various valves during these controls are identical.

During these controls, current to all the electromagnetic valves STR, SREC, SMCF, SREA is turned ON. In other words, the electromagnetic opening/closing valves SREC and SMCF are in a closed state, and the electromagnetic opening/closing valves STR and SREA are in an opened state. Meanwhile, current is appropriately switched ON and OFF to the pressure increase control valves PC1 to PC4 and the pressure decrease control valves PC5 to PC8 corresponding to the wheels subject to control.

In this case, since the electromagnetic opening/closing valves SREC, SMCF are in a closed state, the master cylinder MC is not connected to the wheel cylinders Wfr to Wrl. However, hydraulic pressure generated in the regulator RG can be applied via CV5 by pressing down the brake pedal BP. Furthermore, the accumulator Acc is connected to the wheel cylinders Wfr to Wrl, since the electromagnetic opening/closing valves STR, SREA are in an opened state.

Accordingly, brake hydraulic pressure accumulated in the accumulator Acc is transmitted via the electromagnetic opening/closing valves STR, SREA. Meanwhile, the pressure increase control valves PC1 to PC4 and the pressure decrease control valves PC5 to PC8 corresponding to the wheels subject to control are appropriately switched between opened and closed states, whereby brake hydraulic pressure is transmitted to the wheel cylinders Wfr to Wrl corresponding to the wheels subject to control. Therefore, a braking force is generated on the wheels subject to control, that is, the four wheels FR to RL, and the TCS control, BA control, and ESC control are thus executed.

According to the vehicular brake control device of the present embodiment as described above, the electromagnetic opening/closing valves SMCF, SREA are both configured as two-position valves with two ports, and are capable of executing various controls as required in the event of an emergency, in addition to normal braking.

As described above, a configuration for the vehicular brake control device can therefore be achieved using the two positions of the two ports. It is thus possible to simplify both the valve and configurations of the brake conduit, whereby the configuration of the vehicular brake control device can be simplified.

In addition, the brake hydraulic pressure to be applied to the wheel cylinders Wfr, Wfl of the front wheels FR, FL is transmitted via only the electromagnetic opening/closing valve SMCF or the electromagnetic opening/closing valve SREA. Therefore, brake hydraulic pressure can be simultaneously transmitted to the wheel cylinders Wfr, Wfl. Furthermore, the transmission of brake hydraulic pressure to the wheel cylinders Wfr, Wfl can be simultaneously closed when the electromagnetic opening/closing valve SMCF or the electromagnetic opening/closing valve SREA is changed to a closed state.

Accordingly, a vehicular brake control device can be achieved that is capable of preventing the timings at which brake hydraulic pressure is transmitted to and cut off from the wheel cylinders Wfr, Wfl from being offset. Therefore, a stable braking force can be generated to both right and left wheels. This effect is particularly effective in cases where a high pressure and high response are required.

Regarding vehicular brake control devices in general, the four wheels may have no brakes if two overlapping failures occur in either the front or rear wheel system. The failures may consist of a loss such as brake fluid leakage from a brake conduit and damage to a sealing portion of a valve that connects the front and rear wheel systems.

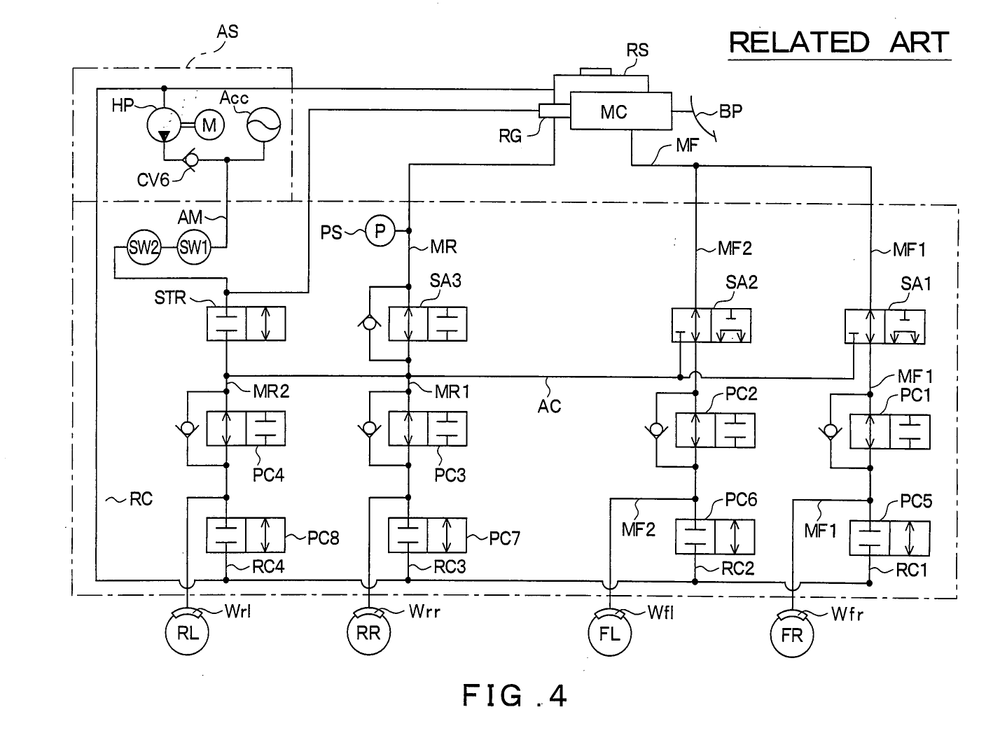

In the case of a conventional vehicular brake control device, for example, the four wheels will have no brakes as described above if two overlapping failures occur: there is damage to either the front or rear wheel system and at least one of the electromagnetic opening/closing valves SA1 or SA2 shown in FIG. 4 has a damaged sealing portion. In the case of the vehicular brake control device according to the present embodiment, the four wheels will have no brakes if the sealing portion of the electromagnetic opening/closing valve SREA shown in FIG. 1 is damaged; however, the number of valves subject to such a possibility is decreased to one, and less than the two valves in related art. Therefore, the probability of damage resulting in the four wheels having no brakes is smaller compared to related art.

Furthermore, in the vehicular brake control device according to the present embodiment, it is preferable for the direction of the check valve (direction in which a spring biases the valve body) within the electromagnetic opening/closing valve SREA connecting the front and rear wheel systems to be set in a direction that prohibits the flow of brake fluid from the front wheel system to the rear wheel system.

According to such a configuration, brake hydraulic pressure can still be generated to the front wheel system to secure front partial performance, even if there is a loss in power such as no generation of brake fluid pressure to the rear wheel system.

Strengthening the spring of the check valve can secure front partial performance even when the direction of the check valve is opposite from that described above. However, in consideration of cases where a spring force cannot be obtained due to damage such as spring breakage, it is preferable to set the direction of the check valve as described above.

An orifice diameter of the electromagnetic opening/closing valve SREA in the vehicular brake control device according to the present embodiment is set based upon the relation between the orifice diameters of the pressure increase control valves PC1, PC2 in the front wheel system. More specifically, the following three elements are used to set the orifice diameter of the electromagnetic opening/closing valve SREA.

(1) In order to satisfy a range for a pressure increase gradient required during ABS control, an orifice diameter ØSREA is set between a lower limit ØA and an upper limit ØB for the range.

(2) In modes where brake hydraulic pressure is automatically applied to the wheel cylinders Wfr, Wfl such as during ESC control, it is preferable for the orifice diameter ØSREA of the electromagnetic opening/closing valve SREA to be set as large as possible.

(3) During ABS control when the vehicle is traveling in a location with different road surfaces μ for the front wheels FL, FR, the timing to increase pressure to the wheel cylinders Wfr, Wfl corresponding to the front wheels FR, FL may be synchronized. In such a case, the brake hydraulic pressure downstream of the electromagnetic opening/closing valve SREA cannot attain a sufficiently high pressure if the orifice diameter of the electromagnetic opening/closing valve SREA is excessively small. Consequently, the brake hydraulic pressure applied to the wheel cylinder on a high μ side passes through the orifice within the pressure increase control valve PC1 and the CV1, and ends up being used to apply pressure to the wheel cylinder Wfr on a low μ side. Therefore, insufficient brake hydraulic pressure is applied to the wheel cylinders Wfr, Wfl, resulting in inadequate deceleration. For this reason, it is preferable that the orifice diameter ØSREA of the electromagnetic opening/closing valve SREA be made as large as possible.

As described above, making the orifice diameter ØSREA of the electromagnetic opening/closing valve SREA as large as possible is preferable. However, in reality, the orifice diameter ØSREA must be set limited to a certain value for the sake of ensuring a small electromagnetic opening/closing valve SREA.

Taking into consideration the above items (1) to (3), it is thus preferable, for example, to set the orifice diameter ØSREA of the electromagnetic opening/closing valve SREA to approximately 80% of the size of the orifice diameters of the pressure increase control valves PC1, PC2.

By setting the orifice diameter ØSREA of the electromagnetic opening/closing valve SREA in such a manner, the electromagnetic opening/closing valve SREA can be made small while satisfying the above items (1) to (3) at the same time.

In addition, an automatic brake control may also be executed by using linear valves for the electromagnetic opening/closing valves STR, SREC shown in the present embodiment. If the electromagnetic opening/closing valves STR, SREC are configured as linear valves in this manner, pressure downstream of the electromagnetic opening/closing valve STR can be gradually increased by the electromagnetic opening/closing valve STR, and pressure downstream of the electromagnetic opening/closing valve SREC can be gradually decreased by the electromagnetic opening/closing valve SREC. Thus, brake hydraulic pressure can be automatically applied in a normal area with no tire slippage.

As shown in FIG. 3 for example, during automatic brake control, current to the electromagnetic opening/closing valves STR, SREC is turned ON, whereby pressure is regulated by the linear valves. Current to the electromagnetic opening/closing valve SMCF is also turned ON and current to SREA is turned ON or OFF. Furthermore, all current to the pressure increase control valves PC1 to PC4 and the pressure decrease control valves PC5 to PC8 is turned OFF.

Thus as described above, pressure is regulated by the electromagnetic opening/closing valves STR, SREC serving as linear valves so that pressure downstream of the electromagnetic opening/closing valve STR can be gradually increased by the electromagnetic opening/closing valve STR, and pressure downstream of the electromagnetic opening/closing valve SREC can be gradually decreased by the electromagnetic opening/closing valve SREC.

### Other Embodiments

In a first embodiment, a simple two-position valve configuration was employed that switched various valves between an opened state and a closed state. However, one of the valve positions may be configured as a differential pressure regulating valve designed to generate a predetermined difference in pressure among brake hydraulic pressures on upstream and downstream sides thereof.

While the above description is of the preferred embodiments of the present invention, it should be appreciated that the invention may be modified, altered, or varied without deviating from the scope and fair meaning of the following claims.

What is claimed is:

1. A vehicular brake control device comprising:
a reservoir that is mounted in a vehicle and stores a fluid;
a hydraulic pump that raises the fluid stored in the reservoir to a predetermined pressure and discharges the fluid;
an accumulator that accumulates a discharged hydraulic pressure from the hydraulic pump;
a hydraulic monitoring mechanism that detects a pressure of fluid accumulated in the accumulator;
a control unit that drives the hydraulic pump in accordance with a detection result from the hydraulic monitoring mechanism such that the hydraulic pressure of the accumulator is within a predetermined range;
a master cylinder that generates a fluid pressure in accordance with an operation amount of a brake operating member;
first and second wheel cylinders for generating a braking force to a first and second wheels;
third and fourth wheel cylinders for generating a braking force to a third and fourth wheels;
a first brake conduit that is provided with a first electromagnetic opening/closing valve and branches into two downstream of the first electromagnetic opening/closing valve and connects to the master cylinder and the first and second wheel cylinders via the first electromagnetic opening/closing valve;
first and second pressure increase control valves that are provided among the branched brake conduits of the first brake conduit, and which are connected to the first and second wheel cylinders, respectively;
first and second pressure decrease control valves that are provided downstream of the first and second pressure increase control valves, and which allow the fluid generating fluid pressure to be applied to the first and second wheel cylinders to escape to the reservoir;
a second brake conduit that is provided with a second electromagnetic opening/closing valve and branches into two downstream of the second electromagnetic opening/closing valve and connects to the master cylinder and third and fourth wheel cylinders via the second electromagnetic opening/closing valve;
third and fourth pressure increase control valves that are provided among the branched brake conduits of the second brake conduit, and which are connected to the third and fourth wheel cylinders, respectively;
third and fourth pressure decrease control valves that are provided downstream of the third and fourth pressure increase control valves, and which allow the fluid generating fluid pressure to be applied to the third and fourth wheel cylinders to escape to the reservoir;
a third brake conduit that is provided with a third electromagnetic opening/closing valve, and which guides fluid pressure accumulated in the accumulator to between the second electromagnetic opening/closing valve in the second brake conduit and the third and fourth electromagnetic opening/closing valves via the third electromagnetic opening/closing valve; and
a fourth brake conduit that is provided with a fourth electromagnetic opening/closing valve, and which connects the first brake conduit between the first electromagnetic opening/closing valve and the first and second pressure increase control valves, and the second brake conduit between the second electromagnetic opening/closing valve and the third and fourth pressure increase control valves, via the fourth electromagnetic opening/closing valve, wherein
the first and fourth electromagnetic opening/closing valves are formed from two-position valves with two ports.

2. The vehicular brake control device according to claim 1, wherein if the first and second wheels correspond to both front wheels, the first and second wheel cylinders apply fluid pressure to both front wheels, respectively, the third and fourth wheels correspond to both rear wheels, and the third and fourth wheel cylinders apply fluid pressure to both rear wheels, respectively, then
a sealing direction of a valve of the fourth electromagnetic opening/closing valve is set in a direction that only allows the fluid to flow from the second brake conduit side to the first brake conduit side.

3. The vehicular brake control device according to claim 2, wherein an orifice diameter of the fourth electromagnetic opening/closing valve is set to a size that is at least 80% of an orifice diameter of the first and second pressure increase control valves.

4. The vehicular brake control device according to claim 3, wherein during normal braking the first and second electromagnetic opening/closing valves are in an opened state, and the third and fourth electromagnetic opening/closing valves are in a closed state, whereas the first to fourth pressure increase control valves are in an opened state and the first to fourth pressure decrease control valves are in a closed state.

5. The vehicular brake control device according to claim 3, wherein during an anti-skid control the first and third electromagnetic opening/closing valves are in a closed state, and the second and fourth electromagnetic opening/closing valves are in an opened state, whereas that among the first to fourth pressure increase control valves corresponding to a wheel subject to control is controlled to an opened state and a closed state and that among the first to fourth pressure decrease control valves corresponding to a wheel subject to control is controlled to an opened state and a closed state.

6. The vehicular brake control device according to claim 3, wherein during a traction control in which a braking force is applied to only the third and fourth wheels, the first and third electromagnetic opening/closing valves are in an opened state, and the second and fourth electromagnetic opening/closing valves are in a closed state, whereas that among the third and fourth pressure increase control valves corresponding to a wheel subject to control is controlled to an opened state and a closed state and that among the third and fourth pressure decrease control valves corresponding to a wheel subject to control is controlled to an opened state and a closed state.

7. The vehicular brake control device according to claim 3, wherein during a traction control, a brake assist control and a sideslip prevention control in which a braking force is applied to any one of the four wheels, the first and second electromagnetic opening/closing valves are in a closed state, and the third and fourth electromagnetic opening/closing valves are in an opened state, whereas that among the first to fourth pressure increase control valves corresponding to a wheel subject to control is controlled to an opened state and a closed state and that among the first to fourth pressure decrease control valves corresponding to a wheel subject to control is controlled to an opened state and a closed state.

8. The vehicular brake control device according to claim 1, wherein the third electromagnetic opening/closing valve is formed from a linear valve, and formed such that pressure can be gradually increased in the first to fourth wheel cylinders by driving the linear valve.

9. The vehicular brake control device according to claim 1, wherein the second electromagnetic opening/closing valve is formed from a linear valve, and formed such that pressure can be gradually decreased in the first to fourth wheel cylinders by driving the linear valve.
